(19) United States
(12) Patent Application Publication
(10) Pub. No.: US 2012/0273410 A1
(43) Pub. Date: Nov. 1, 2012

(54) Metal Semi-Finished Product

(75) Inventors: Andreas HOFENAUER, Eichenau (DE); Christoph SORG, Muenchen (DE); Ralf MARKUSCH, Muenchen (DE)

(73) Assignee: MANN+HUMMEL GMBH, Ludwigsburg (DE)

(21) Appl. No.: 13/071,747

(22) Filed: Mar. 25, 2011

Related U.S. Application Data
(63) Continuation of application No. PCT/EP2009/062413, filed on Sep. 25, 2009.

(30) Foreign Application Priority Data
Sep. 26, 2008 (DE) 10 2008 042 415.3

(51) Int. Cl. C08L 3/00; B32B 3/12; B32B 37/00; B05D 3/02; B05D 3/10; B32B 3/28; C09K 5/00; E04B 1/78; C08K 3/08; B01J 32/00; B01J 31/06; H01B 1/22; D21H 17/45; B32B 1/08; B32B 27/06; C22C 33/00; B22F 1/00; B01D 39/00; B01D 39/14; B32B 27/00

(52) U.S. Cl. 210/504; 428/220; 428/116; 156/182; 427/385.5; 427/387; 428/182; 524/13; 252/75; 252/62; 502/439; 502/159; 252/512; 162/164.6; 428/36.9; 428/458; 75/330; 75/228; 210/505; 55/524; 55/523

(57) ABSTRACT

A semi-finished product is disclosed including fibrous materials, binders, 15 to 90% by volume metal fillers, and 0 to 15% by volume non-metal inorganic fillers. The total content of the fillers is not more than 90% by volume of the semi-finished product. The invention further relates to metal materials and processes for manufacturing the materials and semi-finished products and uses thereof.

### CROSS REFERENCE TO RELATED APPLICATIONS

This application is a bypass-continuation of international PCT application PCT/EP2009/062413, filed Sep. 25, 2009 and published as WO 2010/034792 A1, which is hereby incorporated by reference in its entirety. Through PCT/EP2009/062413 this application claims the benefit under 35 USC 119 of foreign application DE 10 2008 042 415.3 filed in Germany on Sep. 26, 2008, and which is hereby incorporated by reference in its entirety.

### TECHNICAL FIELD

The invention relates to metal semi-finished products, metal materials, and processes for manufacturing the materials and semi-finished products and uses thereof.

### BACKGROUND OF THE INVENTION

Porous sintered metal structures, which are installed in the exhaust system of a diesel combustion engine as particle filters for example, are prior art. For example, DE 10128936 A1 discloses a porous sintered metal structure consisting of wedge-shaped filter pouches.

Processes for manufacturing sintered metal filters which make use of an expanded metal supporting structure are known commercially. In the prior art, expanded metal structures of this type are enhanced with sintered metal in various ways before the sintering process. Thus, it is known commercially for a spreadable paste to be manufactured from sintered metal powder and as small a content as possible of organic binders, and to be doctored into the metal woven fabric or expanded metal in the manner of a star feeder.

It is likewise known that a free-flowing paste or a slip can be manufactured from sintered metal powder, organic binders and solvent. Subsequently, the sintered metal powder processed in this manner is applied by immersing the metal woven fabric or expanded metal in the paste or slip. The slip can also be poured over or the paste pressed onto the metal woven fabric or the expanded metal in a casting process. In all variants, a subsequent drying process is required to evaporate the solvent and to fix the sintered metal on the metal frame.

It is also known to mix sintered metal powder with wax and to apply it to a metal frame, for example in the form of an expanded metal grid, after heating the plastic mass.

Irrespective of the process for coating the metal woven fabric or expanded metal, it is difficult to adjust the layer thickness and layer density precisely. In addition, the expanded metal increases the weight and costs of the resulting filter mat. Accordingly, it is desirable to be able to dispense with a frame material, and still produce a planar, defined and stable filter mat. Patent WO 2006/008222 solves this problem, disclosing the following steps:

a. producing a mixture from a sintered metal powder and an organic binder;

b. producing a film from said mixture;

c. structuring said film; and

d. sintering it.

In this process, a sintered metal film is used as a semi-finished product, and in the raw state (before sintering) has a particular inherent stability for being transferred into conventional filter structures.

In the context of paper production, the primary function of inorganic fillers is to reduce costs and supplement the properties. Accordingly, the properties of the paper are modified by the filler. Maximum filler contents of 30 to 40% by mass (SC or decor paper) are conventionally sought.

Ceramic materials manufactured from preceramic, sinterable special papers are an important field of application. These papers have been so strongly enhanced with preceramic (forming reactive ceramic phases) or ceramic fillers, at for example 75% by weight, that they can be converted thermally into ceramic materials. DE 103 48 798 A1 discloses papers which are enhanced with the reactive fillers silicon and aluminium. These papers are converted into ceramic materials thermally by pyrolysis and subsequent oxidation. In the process, the fillers react with the carbon formed during pyrolysis to form ceramic phases. This results in a mixed ceramics material having silicon carbide, aluminium oxide and mullite as components. With this process, ceramic structures and components can be produced.

DE 10 2006 022 598 A1 discloses special papers which instead of reactive fillers (Si, Al) comprise unreactive ceramic fillers (for example Al2O3, ZrO2, SiC, Si3N4, zeolites, aluminosilicates) which are cured by sintering. These disclosures all have the goal of ceramic materials after the sintering process.

U.S. Pat. No. 4,421,599 also discloses manufacturing ceramic materials from paper filled with ceramic components.

According to the prior art, sintered metal films are used for manufacturing porous, thin-walled sintered metal structures based on planar semi-finished products. A drawback of manufacturing sintered metal films is the need to use organic, highly volatile solvents for the film manufacturing process, necessitating explosion protection (risk of explosion, work safety) and considerably increasing the process costs. A further drawback is that sintered metal films have a low rigidity and stability because of the lack of fiber reinforcement, and this makes it difficult to produce complex shapes. It would therefore be advantageous to develop a process for a planar, homogeneous and stable sintered metal semi-finished product which is produced on an aqueous basis and additionally comprises organic fibers, for example in the form of cellulose, as a fiber reinforcement.

### SUMMARY OF THE INVENTION

The invention is based on the problem of providing effective processes and means for manufacturing metal structures, which overcome the aforementioned drawbacks. It would in particular be desirable to develop a sintered-metal-enhanced paper which can cost-effectively be produced aqueously by a paper machine by processes conventional for paper at the dimensions conventional for paper, shaped in the manner conventional for paper, and optionally transferred into metal materials by heat treatment.

The problem on which the invention is based is solved in a surprising manner by semi-finished products, processes for manufacturing them, uses and metal materials according to the claims

According to the invention, a planar, metal-enhanced semi-finished product is provided as a metal-enhanced paper, and can surprisingly be produced aqueously by a paper machine by processes conventional for paper at the dimensions conventional for paper. The metal filler can be introduced during the paper manufacturing process. It is not necessary to use volatile organic solvents. By using methodology based on paper technology, a metal semi-finished product of this type can be manufactured considerably more rapidly and on a considerably larger scale than in other processes, such as tape casting. Moreover, the cellulose fibers used in the paper manufacturing process act as a fiber reinforcement in the resulting planar semi-finished product, in such a way that these products are substantially more stable and flexible than sintered metal films manufactured by tape casting, for example. The paper can be shaped by processes conventional for paper, for example into complex shapes relevant for filters, and optionally thermally transferred into a metal material.

The invention relates to a semi-finished product, comprising

(a) organic fibrous materials,

(b) binders

(c) 15 to 90% by volume metal fillers, and

(d) 0 to 15% by volume non-metal inorganic fillers,

the total content of the fillers (c) and (d) together not being more than 90% by volume of the semi-finished product, and all volumes being given based on the solids volume of the semi-finished product.

The amounts are given as proportions of the solids volume. This means the proportion taken up by the volume of the filler used out of the total volume of all of the solids used, which consist of filler, cellulose, latex and further organic binders and/or polymers. The volume of the pores is not taken into account. This makes the claim independent of the density of the fillers used and the compression of the paper. It is advantageous to give the proportions as percentages by volume in this case, because the extent to which the semi-finished product is filled with metals can be described better in this manner. A high metals content by volume generally simplifies sintering because the metal particles are in contact.

The invention makes it possible to enhance a semi-finished product intensively with metal fillers in a paper manufacturing process. The semi-finished product is primarily distinguished by the metal fillers used. A planar metal semi-finished product is obtained which can be used uncompacted or thermally compacted after shaping. Further non-metal fillers may additionally be comprised, but not in an amount significantly influencing the nature of the semi-finished product. Preferably, a considerably smaller amount of non-metal fillers than of metal fillers is comprised. For example, there are no more than 20, 10 or 5 parts non-metal inorganic fillers for 100 parts metal fillers.

In one embodiment, the fibrous material (a) in the semi-finished product does not form a continuous matrix. In this embodiment, the fibrous material content is not sufficient to form a matrix. The binder connects the fillers. In a further embodiment, the metals content is high enough that they contact one another and form a continuous matrix.

The material according to the invention is referred to as a “semi-finished product”. This means that the metal-containing material is provided in a form which can be processed further. However, this does not exclude the possibility of the semi-finished products itself being used as an article of daily use.

In a further embodiment of the invention, the semi-finished product is a paper or card. The paper-like nature of the semi-finished product increases with the content of organic fibrous materials (a). Surprisingly, however, the semi-finished product can be manufactured and processed by processes conventional for paper even if the fibrous material content is too low for it to be paper by the conventional definition.

The semi-finished product according to the invention is solid. It has only a low water content remaining after manufacture, for example less than 5, less than 1 or less than 0.2% by weight. It is preferably stable enough not to decompose with conventional handling and transport.

In a preferred embodiment, a metal material results from sintering the semi-finished product, for example for 10 hours, under conventional conditions, for example at temperatures between 1100 and 1800° C., in particular between 1200° C. and 1700° C. or between 1200° C. and 1600° C., in particular at 1200, 1300 or 1600° C. A “metal material” within the meaning of the invention is a material which has a substantial metals content, thus for example at least 15, 50, 80, 95, 99 or 100% by weight.

In a preferred embodiment, the content of metal fillers (c) in the semi-finished product is at least 20% by volume, preferably at least 50% by volume, particularly preferably at least 76% by volume or at least 85% by volume, based on the solids volume of the semi-finished product. The total filler content is preferably 40-95% by volume or 70 to 95% by volume, in particular 76 to 90% by volume, based on the solids volume of the semi-finished product. Higher contents of metal fillers are advantageous for imparting an increasingly metal-like nature to the semi-finished product. Thus, to make a metal-powder-enhanced paper sinterable, the sintered metal particles have to be sufficiently close in space. This is provided to a greater extent the more metal filler is contained in the paper.

Preferably, at least 20% by volume, preferably 35% by volume, particularly preferably 45% by volume or 55% by volume metal powder is comprised based on the solids volume. Since the metals have a considerably higher density than the organic components, this corresponds to very high contents in % by weight. At an apparent density of a sintered metal of 8 g/cm³, for example, these solids contents by volume correspond to the following contents by weight based on the total dry mass of the paper: 10% by volume is approximately 37% by mass, 20% by volume is approximately 57% by mass, 35% by volume is approximately 74% by mass, 45% by volume is approximately 81% by mass, and finally 55% by volume is approximately 87% by mass based on the total dry mass of the metal-enhanced paper.

In a preferred embodiment, the semi-finished product comprises at least one metal from the 4th, 5th and 6th periods of the periodic table, optionally in the form of alloys or mixtures. The metal material is for example selected from iron, tungsten, chromium, manganese, molybdenum, nickel, palladium, platinum, titanium, vanadium, niobium, tantalum, copper, silver, gold, aluminum, bronze, brass, tin, tin alloys, lead, lead alloys, zinc, magnesium, Mg alloys, calcium, and mixtures and alloys of these metals, such as steel or high-grade steel. In a preferred embodiment, the metal filler comprises at least one precious metal. Metals which do not react to form carbides, nitrides or oxides during sintering, for example for 10 hours at 1000 to 2000° C., are particularly preferred. In one embodiment, the metal is not silicon and the semi-finished product does not comprise any silicon.

In a preferred embodiment, ceramic fillers, preferably carbides, oxides, nitrides, borides and hydroxides, particularly preferably silicon carbide, boron carbide, titanium carbide, aluminum oxide, zirconium oxide, titanium dioxide, silicon nitride, silicates, aluminosilicates, aluminum nitride, boron nitride and titanium boride, are comprised as non-metal inorganic fillers. In principle, low contents of carbons may also be contained to modify the properties, preferably graphite, activated carbon, soot, diamond, diamond powder, fullerenes, carbon nanotubes or carbon fibers. However, reactive additives of this type are only comprised if or are only comprised in such amounts that they do not cause the metal to react in significant amounts to form a ceramics material. Therefore, a preferred embodiment comprises no elemental carbon such as graphite or soot.

In a preferred embodiment, the content of non-metal fillers is less than 10% by volume, preferably less than 5% by volume and particularly preferably less than 2% by volume based on the solids volume of the semi-finished product.

In a preferred embodiment, the metal and/or the further fillers are in the form of powders and/or fibers, preferably having a particle size and/or fiber diameter of less than 200 μm, particularly preferably less than 100 μm or less than 50 μm. As well as the use of non-fibrous particles as a filler, fiber-like fillers can also be used as what are known as fibrous fillers. The given filler content accordingly comprises both fibrous and non-fibrous fillers. The use of short metal fibers in for example a resulting paper-based sintered metal structure can give this structure a higher strength and/or damage tolerance. At a given apparent density, the smaller the representative particle or fiber diameter, the lower the tendency of the filler towards sedimentation during the paper manufacturing process. Accordingly, with the provided process based on paper technology, the paper can be highly enhanced more easily with finer particles. As for the use of sintered metal particles, particle qualities in the diameter range of less than 50 μm or even less than 30 μm have only been commercially available for a few years.

In a preferred embodiment, the content of organic fibrous materials (a) is 2 to 84.5% by volume, in particular 5 to 50 or 5 to 25% by volume, based on the solids volume of the semi-finished product.

The content of binders (b) is 0.5 to 20% by volume, preferably 1 to 15% by volume or 2 to 10% by volume, based on the solids volume of the semi-finished product. In a preferred embodiment, the binder (b) is latex and/or a natural or derivatised natural polysaccharide, in particular starch. Latex in particular performs a twofold function in this context. On the one hand, the use of latex (emulsion of pre-cross-linked polymers) makes strong flocculation of the filler possible in the paper manufacturing process. As an emulsion, latex forms very fine droplets having diameters in the range of 100-500 nm As a result, a large effective surface area of the latex used is achieved with relatively little active substance. In conjunction with the capacity for film formation, by using latex very large amounts of filler can be highly effectively flocculated, i.e. combined to form aggregates, with further retention agents. In this connection, the flocculation can selectively be regulated further by the use of charged starch. The strong flocculation provides that in the highly aqueous system in the paper manufacture, the filler is held back from the mould when the substance mixture is applied thereto and is not lost together with the white water. On the other hand, in the finished metal-enhanced paper, latex performs the function of a resilient binder. This prevents powdering of the paper (removal of filler). The combination of cellulose fibers and latex additionally makes very high plasticity of the metal-enhanced paper possible. The latex is preferably a polymer dispersion. A polymer dispersion refers to a colloidally stable dispersion of polymer particles in an aqueous phase. The diameter of the polymer particles may be between 10 nanometers and 5 micrometers. Polymer dispersions based on acryl ester vinyl acetate or methyl methacrylate and ethyl acrylate or styrene butadiene or acyl nitrile may for example be used as latexes. In particular, the product branded as Styronal™ 809 (based on styrene butadiene) from BASF and the product branded as Nychem™ 1562×117 (based on acyl nitrile) from Emerald have proven their worth as charged latexes.

Natural polysaccharides may also be used according to the invention. Of these, starch is particularly preferred. Potato starch, maize starch or rice starch may for example be used as starch. Further suitable natural polysaccharides are xanthan gum and those from guar. The natural polysaccharides and the starch may be derivatised, i.e. chemically modified, by known processes.

A preferred embodiment comprises organic binders, preferably phenol resins, and/or inorganic binders, preferably siliceous binders, and/or organometallic polymers, preferably silanes, siloxanes, silazanes and/or hybrid polymers. These binders may for example be used in combination with latex and/or natural or derivatised natural polysaccharides, in particular starch.

In a preferred embodiment, the semi-finished product comprises charged latex and/or natural or derivatised natural polysaccharide, in particular starch, as a binder, the charged latex or the charged starch being present in an amount of 0.05-15% by weight, particularly preferably in an amount of 0.5 to 10% by weight, based on the total dry weight of the semi-finished product. Preferably, anionic latex and/or cationic starch is used.

In a preferred embodiment, the semi-finished product comprises polyvinyl amine, polyacrylamide, polyamide amine, aluminum sulphate and/or bentonite as retention agents, preferably in an amount of 0.01 to 7% by weight, particularly preferably 0.1 to 2% by weight, based on the total dry mass of the semi-finished product. These retention agents may also be used in combination with latex and starch.

In a preferred embodiment, the semi-finished product comprises natural fibers, chemically modified natural fibers or synthetic fibers, in particular based on cellulose, as the organic fibrous material (a). Sulphate cellulose and/or sulphite cellulose and/or cellulose produced by thermomechanical processes (TMP) and/or cellulose produced by chemithermomechanical processes (CTMP) and/or cotton and/or linters, substances comprising lignocellulose, and/or wood pulp are suitable, for example.

In a preferred embodiment, the semi-finished product has a thickness of 50 to 20000 μm, preferably of 100 to 1500 μm.

In a preferred embodiment, the semi-finished product additionally comprises wetting agents and/or dispersing agents, preferably cationic and/or anionically stabilised agents. The wetting and/or dispersing agent is preferably comprised in an amount of 0.05 to 5% by weight, in particular in an amount of 0.1 to 3% by weight, based on the total dry weight of the semi-finished product.

In a preferred embodiment, the semi-finished product experiences a weight loss during complete pyrolysis (which may include complete burning off of combustible components) of less than 50% by weight, preferably less than 40% by weight, particularly preferably less than 30% by weight or less than 20% by weight, based on the total dry weight of the semi-finished product.

In a preferred embodiment, the semi-finished product is shaped using paper technology, preferably as a corrugated board, honeycomb or tubular structure.

In a preferred embodiment, the semi-finished product is shaped using paper technology in combination with a metal support structure, preferably in combination with an expanded metal or in combination with a metal fiber woven fabric, preferably as a corrugated board, honeycomb or tubular structure.

The invention further relates to the use of a semi-finished product according to one or more of the preceding claims for manufacturing a metal material, for example as a filter for gases or liquids, as a catalyst carrier, catalytic converter, heat exchanger, barrier layer, housing component, pore burner or electromagnetic shielding paper.

The invention further relates to a process for manufacturing a semi-finished product according to at least one of the preceding claims, comprising the steps of
mixing the fibrous materials (a), binders (b) and fillers (c) and (d) in a solvent, preferably water, to form a paste; and
processing the paste to form a semi-finished product using a paper machine or an extrusion or injection molding process.

In a preferred embodiment, the semi-finished product is coated with a slip. The slip preferably comprises organic binders and/or metal and/or ceramic and/or carbon-containing and/or lignocellulose-containing additives in the form of powders and/or fibers.

The invention further relates to a process for manufacturing a metal material, a semi-finished product according to the invention accordingly being heat-treated until the organic components are removed. This means for example that the content of organic components makes up less than 1, 0.2 or 0.05% by weight. A largely metal matrix is left behind. The process is carried out in such a way that the metal does not or does not substantially chemically react (for example by less than 10, 5 or 2%), for example to form an oxide, nitride or carbide.

The invention further relates to a process for manufacturing a metal material using a semi-finished product according to the invention, characterized by at least one of the following steps:
infiltration of the semi-finished product with organic binders, preferably phenol resins, and/or with an inorganic binder, preferably with a siliceous binder, with subsequent heat-treatment at a temperature of up to 300° C., preferably up to 200° C., or
infiltration of the semi-finished product with hybrid polymers and/or organometallic polymers, preferably silanes, siloxanes or silazanes, with subsequent heat-treatment at a temperature of up to 300° C., preferably up to 200° C., with subsequent pyrolysis at a temperature of up to 1600° C., preferably up to 1200° C. or up to 800° C., or
pyrolysis of the semi-finished product at a temperature of up to 1200° C., preferably up to 800° C., with subsequent sintering at a temperature of up to 1600° C., preferably up to 1400° C., particularly preferably up to 1200° C. or up to 1000° C., or
pyrolysis of the semi-finished product at a temperature of up to 1200° C., preferably up to 800° C., with subsequent sintering at a temperature of up to 1600° C., preferably up to 1400° C., particularly preferably up to 1200° C. or up to 1000° C., with subsequent infiltration with a metal, preferably aluminum, copper or silicon, at a temperature of up to 1600° C., preferably up to 1400° C.

The semi-finished product according to the invention can also be a laminate of at least two layers. In a specific embodiment of the invention, at least two semi-finished products according to the invention are interconnected during manufacture of the semi-finished product. In this case, the layers are placed flat on top of one another.

In a preferred embodiment of the invention, the layers are connected during the manufacture, using paper technology, of the individual semi-finished product layers or directly after the manufacture of a still moist layer. In this case, the two semi-finished products are preferably interconnected by couching while damp, at a humidity, in particular a water content, of more than 10%, preferably more than 20% and particularly preferably more than 40% by weight. The bonding forces are then provided when the laminate dries.

In a further embodiment of the invention, the at least two semi-finished products are connected with a binder. The binder is preferably an organic binder, in particular starch, latex or polyvinyl alcohol. A hybrid polymer, an organometallic polymer or a mixture of these substances is also suitable. In this case, the semi-finished product layers can be provided with the binder and adhesively bonded. In a further embodiment, the binder comprises metal fillers.

The invention further relates to a metal material obtainable by a process according to the invention. The materials according to the invention comprise a largely metal matrix. They are preferably stable under mechanical strain. They are preferably porous, the content of the pores preferably making up 20 to 95% or particularly preferably 30 to 70% of the volume of the material. The pore sizes in this case are for example between 1 and 2000 μm, preferably between 30 and 500 μm, for at least 95% or at least 95% of the pores. The average pore size is preferably between 1 and 2000 μm, preferably between 30 and 500 μm. A biomorphous pore shape or pore structure is preferably obtained in the thermal removal of the cellulose fibers.

The material according to the invention has a high metal content or substantially consists of metal. A metal content of at least 60, 75, 70, 95 or 99% by weight is preferred. The material according to the invention and the semi-finished products having a high metal content thus differ from the ceramic materials and semi-finished products from DE 10 2006 022 598 A1 which in all cases have a low metal content.

The invention further relates to the use of the semi-finished product or the metal material as a filter for gases or liquids, as a catalyst support, catalytic converter, heat exchanger, barrier layer, housing component, pore burner, membrane, surface burner, heat insulation, electrode, hot tube, heat exchanger tube, condenser or lightweight construction, or for shielding from radiation, in particular electrosmog, X-ray waves or radar waves.

The invention also relates to filters for gases or liquids, a catalyst support, catalytic converter, heat exchanger, barrier layer, housing component, pore burner, membrane, surface burner, heat insulation, electrode, hot tube, heat exchanger tube, condenser, lightweight construction, or covering for shielding from radiation, in particular electrosmog, X-ray waves or radar waves, comprising a semi-finished product or material according to the invention. The semi-finished products according to the invention are particularly suitable as devices such as lightweight constructions or coverings for shielding from radiation.

The potential benefit of the present invention resides in the provision of a planar, homogeneous, stable and plastic metal semi-finished product, which because of the cellulose fibers acting as a fiber reinforcement can be transferred into structures relevant to applications without a metal support structure.

It is likewise advantageous that a paper of this type can be manufactured on the scale and at the costs conventional for paper using aqueous paper technology, i.e. without organic solvents.

It is advantageous that the thickness, density and microstructure of the metal paper can be adjusted precisely, making possible for example precise control of the properties such as strength and microstructure of the resulting metal material in the case of thermal conversion.

It is likewise advantageous that in the case of thermal conversion, the porosity and microstructure of the resulting metal material can be controlled by way of the thermal decomposition of the cellulose fibers.

It is likewise advantageous that the metal-enhanced paper can be impregnated using paper technology (for example by size press) and/or coated using paper technology (for example couching, spreading) and/or printed (for example screen printing).

It is advantageous that because of the fiber reinforcement of the organic fibers used, such as cellulose, metal-enhanced paper can be transferred well into shapes, for example filter structures, which are relevant to the applications by shaping using paper technology, such as rippling (corrugated board production) and/or winding (winding tube manufacture).

It is likewise advantageous that papers which are filled with powders differing in composition and/or particle size can be combined with one another, for example so as to obtain particular filter properties in the case of thermal conversion.

The possibility of also being able to introduce metal fibers in the paper manufacture process as well as metal particles, in such a way that the metal-enhanced paper can comprise metal fibers as well as metal particles, is likewise advantageous.

It is additionally advantageous that the aqueous suspension consisting of cellulose, metal and organic binders and possible further additives such as latex can be formed so as to be 3-dimensional, as well as planar, by injection molding or extrusion, rather than being formed so as to be planar by a paper manufacturing process.

The possibility of connecting the metal-enhanced paper to a metal support structure such as an expanded metal is also advantageous.

It is likewise advantageous that because of the high content of metal fillers, in the case where it is sinterable the paper or paper structure can be effectively transferred into a metal material.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows a corrugated semi-finished product according to the invention filled with high-grade steel powder;

FIG. 2 shows the cross-section of a semi-finished product filled with high-grade steel powder (filler content 87% by weight, corresponding to approximately 50% by volume as a proportion of the solids volume), consistent with the present invention; and

FIG. 3 shows the cross-section of a semi-finished product filled with high-grade steel powder (filler content 87% by weight, corresponding to approximately 50% by volume as a proportion of the solids volume), consistent with the present invention.

### DETAILED DESCRIPTION OF EMBODIMENTS

Before describing in detail embodiments that are in accordance with the present invention, it should be observed that the embodiments reside primarily in combinations of apparatus components and process or method steps related to a metal semi-finished product according to the present disclosure. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

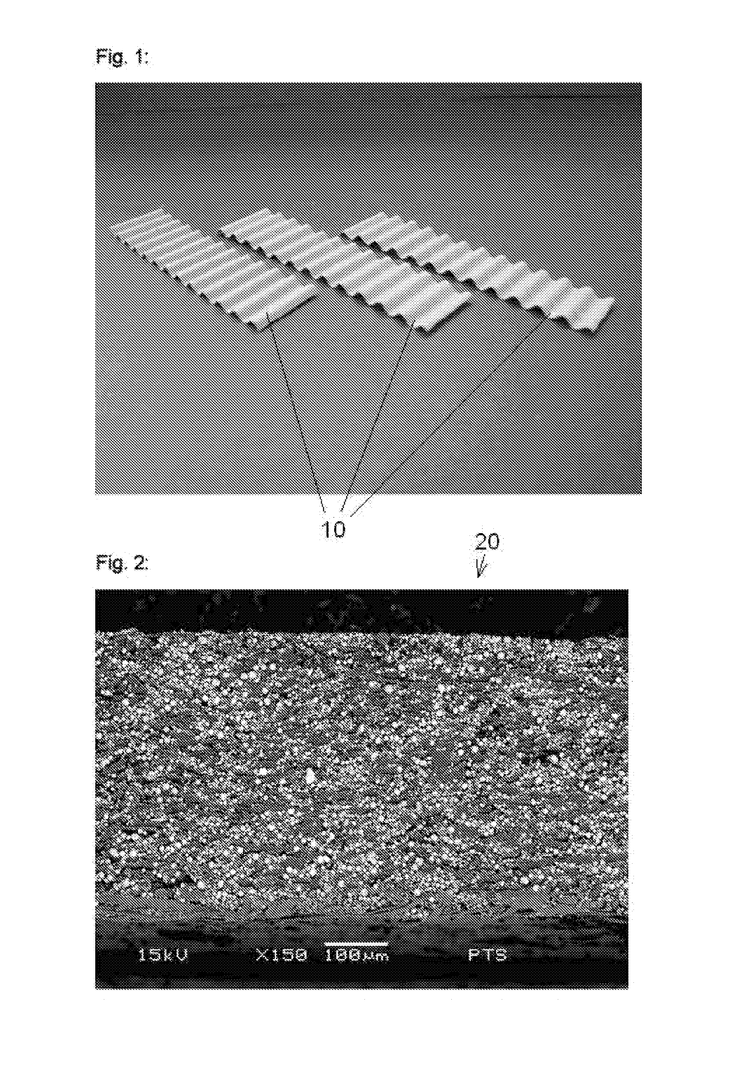

FIG. 1 shows a corrugated semi-finished product 10 according to the invention filled with high-grade steel powder.

FIG. 2 shows the cross-section of a semi-finished product 20 filled with high-grade steel powder (filler content 87% by weight, corresponding to approximately 50% by volume as a proportion of the solids volume), consistent with the present invention.

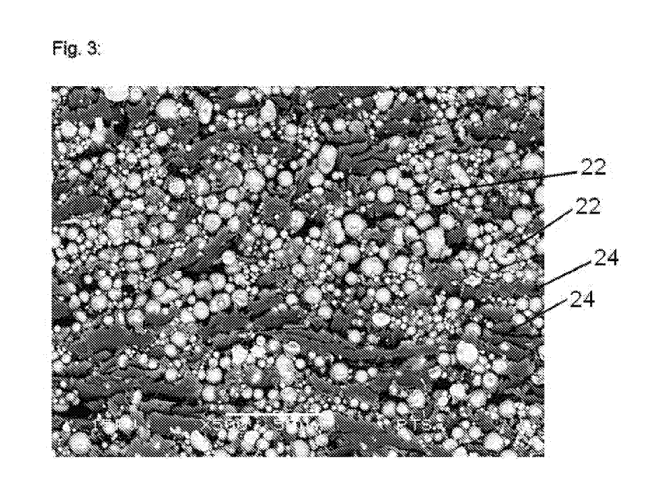

FIG. 3 shows a higher resolution zoom view of the cross-section of a semi-finished product 20 filled with high-grade steel powder (filler content 87% by weight, corresponding to approximately 50% by volume as a proportion of the solids volume), depicting metal fillers 22 and cellulose fibers 24 consistent with the present invention.

### Example 1

### Semi-Finished Product Comprising High-Grade Steel

A semi-finished product was produced from the following components: unbleached softwood (9.97% by mass based on total paper (abs. dry)), cationic maize starch (0.5% by mass based on total paper (abs. dry)), high-grade steel powder (FeCrNiMoMnSi) Ampersint™ 0717.02; H. C. Starck (87% by weight based on total paper (abs. dry)), latex (anionic; 2.5% by weight based on total paper (abs. dry)), cationic polyacrylamide; (0.03% by mass based on total paper (abs. dry)).

The high-grade steel powder Amersint™ 0717.02 has the following composition:

| | |
|---|---|
| Cr | 16.5% |
| Ni | 10.2% |
| Mo | 2.3% |
| Mn | 1.4% |
| Si | 0.4% |
| C | 0.032% |
| S | 0.005% |
| P | <0.01% |
| Fe | remainder |

The particle size distribution is:

| | |
|---|---|
| D90 | 12.9 μm |
| D50 | 10.6 μm |
| D10 | 3.4 μm |

Preparation of the Individual Components

Cellulose. Impact the dry cellulose with approximately 2 litres of tap water using a disintegrator (for example the MK III C from Messmer) for 20 minutes. Dilute the obtained cellulose suspension with tap water until a solids content of 0.5%.

Cationic maize starch: Boil up at approximately 3% with tap water for 60 minutes at 95° C. while stirring, then dilute to approximately 1% with cold water and stir for 20 minutes. Allow to cool to room temperature. Identify solids content.

High-grade steel powder: Weigh in directly.

Latex: Dilute to a solids content of 4% with tap water.

Cationic polyacrylamide: Dilute to a solids content of 0.0226% with tap water while stirring.

### Manufacturing a Laboratory Sheet

A circular laboratory sheet having a diameter of 20 cm and a grammage of 318.3 g/m2 was manufactured on the laboratory sheet former (for example the G8 KT from Gockel) by the Rapid Kothen process. For this purpose, 202.09 g of a cellulose suspension (solids content 0.5%) are placed in a borosilicate beaker (capacity 600 ml). 4.74 g of a cationic starch suspension (solids content 1.06%) are added while stirring at 700 rpm using a laboratory stirrer (for example IKA RW 20 DZM). After further stirring for 30 seconds, 8.7 g of high-grade steel powder are added. After stirring for a further 30 seconds, 6.25 g of an anionic latex emulsion (solids content 4%) are added. After continued stirring for 1 minute, 13.29 g of a cationic polyacrylamide (solids content 0.226%) are added and stirred for one more minute. The resulting mixture is introduced into a Rapid Kothen sheet former. The sheet produced is dried for 10 minutes under vacuum at 96° C. FIGS. 2 and 3 are cross-sections through the semi-finished product. The semi-finished product has a solids content of approximately 50% by volume.

Paper filled with high-grade steel powder and produced in this manner was compacted at 90° C. using a calender at a line pressure of 90 KN/m and rippled into a C-wave by a rippling unit. Rippled paper samples were subsequently pre-sintered in an oxygen atmosphere at a maximum temperature of 1000° C. This removed all of the organic components by oxidation and provided a first compaction of the high-grade steel particles. Subsequently, complete sintering is to be carried out as required by a conventional process for sintering high-grade steel powders. Sintering temperatures in the range of 1000-1600° C. in a hydrogen atmosphere or noble gas atmosphere or vacuum are conventional for this purpose, and the sintering was carried out between 1000 and 1400° C.

### Example 2

### Semi-Finished Product Comprising Iron

A semi-finished product was manufactured from the following components:
unbleached softwood (9.97% by mass based on total paper (abs. dry)), cationic maize starch (0.5% by mass based on total paper (abs. dry)), carbonyl iron powder (Carbonyl iron SQ, Imhoff & Stahl; 87% by weight based on total paper (abs. dry)),
latex (anionic; 2.5% by weight based on total paper (abs. dry)), polyacrylamide; (cationic, 0.03% by mass based on total paper (abs. dry)).

The components were prepared and the paper was manufactured as in example 1. Paper filled with carbonyl iron and produced in this manner was compacted at 90° C. using a calender at a line pressure of 90 KN/m and rippled into a C-wave by a rippling unit. Rippled paper samples were subsequently pre-sintered in an oxygen atmosphere at a maximum temperature of 1000° C. This removed all of the organic components by oxidation and provided a first compaction of the iron particles. Subsequently, complete sintering is to be carried out as required by a conventional process for sintering metals. Sintering temperatures in the range of 1000-1600° C. in a hydrogen atmosphere or noble gas atmosphere or vacuum are conventional for this purpose, and the sintering was carried out between 1000 and 1400° C.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A semi-finished product, comprising:
(a) organic fibrous materials;
(b) binders;
(c) 15 to 90% by volume metal fillers; and
(d) 0 to 15% by volume non-metal inorganic fillers,
wherein total content of the fillers (c) and (d) together not being more than 90% by volume of the semi-finished product, and
wherein all volumes being given based on the solids volume of the semi-finished product.

2. The semi-finished product according to claim 1, wherein the binder (b) is latex and/or a natural or derivatised natural polysaccharide starch.

3. The semi-finished product according to claim 1, wherein
the content of organic fibrous materials (a) is 2 to 84.5% by volume, and
the content of binders (b) is 0.5 to 20% by volume, based on the solids volume of the semi-finished product.

4. The semi-finished product according to claim 1, wherein the organic fibrous material (a) does not form a continuous matrix.

5. The semi-finished product according to claim 1, wherein a metal material results during sintering of said semi-finished product for 10 hours, at 1200, 1300 or 1600 Å° C.

6. The semi-finished product according to claim 1, wherein the content of metal fillers (c) is at least 45% by volume based on the solids volume of the semi-finished product and/or the total filler content is 45 to 90% by volume based on the solids volume of the semi-finished product.

7. The semi-finished product according to claim 1, wherein said semi-finished product comprises at least one metal from the 4th, 5th and 6th main groups or a transition group of the periodic table.

8. The semi-finished product according to claim 1, wherein the metal material is selected from iron, tungsten, chromium, manganese, molybdenum, nickel, palladium, platinum, titanium, vanadium, niobium, tantalum, copper, silver, gold, aluminum, bronze, brass, tin, tin alloys, lead, lead alloys, zinc, magnesium, Mg alloys, calcium, and mixtures and alloys of these metals.

9. The semi-finished product according to claim 1, wherein ceramic fillers are selected from the group consisting of carbides, oxides, nitrides, borides and hydroxides, silicon carbide, boron carbide, titanium carbide, aluminum oxide, zirconium oxide, titanium dioxide, silicon nitride, silicates, aluminosilicates, aluminum nitride, boron nitride and titanium boride,
and/or lignocellulose-containing fillers, and/or carbons selected from the group consisting of
graphite, activated carbon, soot, diamond, diamond powder, fullerenes, carbon nanotubes or carbon fibers, are used as non-metal inorganic fillers.

10. The semi-finished product according claim 9, wherein the content of non-metal fillers is less than 5% by volume, based on the solids volume of the semi-finished product.

11. The semi-finished product according to claim 9, wherein the metal and/or the further fillers are in the form of powders and/or fibers having a particle size and/or fiber diameter of less than 200 μm.

12. The semi-finished product according to claim 1, wherein the semi-finished product comprises organic binders selected from the group including phenol resins, and/or other binders selected from the group including inorganic binders, siliceous binders, and/or organometallic polymers, including silanes, siloxanes, silazanes and/or hybrid polymers.

13. The semi-finished product according to claim 1, wherein the semi-finished product comprises sulphate cellulose and/or sulphite cellulose and/or cellulose produced by thermomechanical processes (TMP) and/or cellulose produced by chemithermomechanical processes (CTMP) and/or cotton and/or linters, and/or wood pulp and/or synthetic fibres as the fibrous material.

14. The semi-finished product according to claim 1, wherein the semi-finished product has a thickness of 50 to 20000 μm.

15. The semi-finished product according to claim 1, wherein the semi-finished product additionally comprises cationic and/or anionically stabilized wetting agents and/or dispersing agents, the wetting and/or dispersing agent being comprised in an amount of 0.05 to 5% by weight based on the total dry weight of the semi-finished product.

16. The semi-finished product according to claim 2, wherein the semi-finished product comprises charged latex and/or charged starch, the charged latex or the charged starch being present in an amount of 0.05-15% by weight based on the total dry weight of the semi-finished product.

17. The semi-finished product according to claim 1, wherein the semi-finished product comprises polyvinyl amine, polyacrylamide, polyamide amine, aluminum sulphate and/or bentonite as retention agents in an amount of 0.01 to 7% by weight, based on the total dry mass of the semi-finished product.

18. The semi-finished product according to claim 1, wherein the semi-finished product experiences a weight loss during complete pyrolysis of less than 50% by weight, based on the total dry weight of the semi-finished product.

19. The semi-finished product according to claim 1, wherein the semi-finished product is shaped using paper technology, preferably as a corrugated board, honeycomb or tubular structure.

20. The semi-finished product according to claim 1, wherein
the semi-finished product is shaped using paper technology on or in combination with a metal support structure of an expanded metal or in combination with a metal fiber woven fabric,
wherein the semi-finished product is shaped as a corrugated board, honeycomb or tubular structure.

21. The semi-finished product according to claim 1, wherein a plurality of semi-finished product layers are arranged in layers and securely connected together to form a laminate.

22. The semi-finished according to claim 1, wherein the semi-finished product is used for manufacturing a metal material.

23. A process for manufacturing a semi-finished product according to claim 1, the process comprising the steps of:
mixing the fibrous materials (a), binders (b) and fillers (c) and (d) in a solvent to form a paste; and
processing the paste to form a semi-finished product using a paper machine or an extrusion or injection molding process.

24. The process of claim 23, further comprising
coating the semi-finished product with a slip.

25. The process according to claim 24, wherein in the coating step, the slip comprises organic binders and/or metal and/or ceramic and/or carbon-containing and/or lignocellulose-containing additives in the form of powders and/or fibers.

26. The process according to claim 23, further comprising the step of
layering together and connecting together at least two semi-finished products to form a layered semi-finished product.

27. A process for manufacturing a metal material, wherein a semi-finished product according to claim 23 is heated until the organic components are removed.

28. A process for manufacturing a metal material using a semi-finished product according to claim 1, comprising at least one of the following steps:
infiltrating the semi-finished product with organic binders, and/or with an inorganic binder, with subsequent heat-treatment at a temperature of up to 300 degrees C.;
infiltrating the semi-finished product with a prephenol resin binder and/or with a siliceous binder, with subsequent heat-treatment at a temperature of up to 300 degrees C.;
infiltrating the semi-finished product with hybrid polymers and/or organometallic polymers, preferably silanes, siloxanes or silazanes, with subsequent heat-treatment at a temperature of up to 300 degrees C.;
infiltrating the semi-finished product with hybrid polymers and/or organometallic polymers selected from the group consisting of silanes, siloxanes or silazanes, with subsequent heat-treatment at a temperature of up to 300 degrees C., with subsequent pyrolysis at a temperature of up to 1600 degrees C.;
pyrolysis of the semi-finished product at a temperature of up to 1200 degrees C., with subsequent sintering at a temperature of up to 1600 degrees C.;
pyrolysis of the semi-finished product at a temperature of up to 1200 degrees C., with subsequent sintering at a temperature of up to 1600 degrees C., with subsequent infiltration with a metal selected from the group consisting of aluminium, copper or silicon, at a temperature of up to 1600 degrees C.

29. A porous metal material produced by the process according to claim 28.

30. A use of a semi-finished product according to claim 1 as a porous metal filter for gases or liquids, as a diesel combustion engine, as a catalyst support, catalytic convertor, heat exchanger, barrier layer, housing component, pore burner, membrane, surface burner, heat insulation, electrode, hot tube, heat exchanger tube, condenser or lightweight construction, or for shielding from radiation, in particular electrosmog, X-ray waves or radar waves.

31. A use of a metal material according to claim 29 as a porous metal filter for gases or liquids, as a diesel combustion engine, as a catalyst support, catalytic convertor, heat exchanger, barrier layer, housing component, pore burner, membrane, surface burner, heat insulation, electrode, hot tube, heat exchanger tube, condenser or lightweight construction, or for shielding from radiation, in particular electrosmog, X-ray waves or radar waves.

32. A metal product produced by the process according to claim 28, wherein the product is a catalyst support, catalytic converter, heat exchanger, barrier layer, housing component, pore burner, membrane, surface burner, heat insulation, electrode, hot tube, heat exchanger tube, condenser or lightweight construction, or for shielding from radiation, or shielding from X-ray waves or radar waves.
